(19) United States
(12) Patent Application Publication
(10) Pub. No.: US 2026/0260021 A1
(43) Pub. Date: Sep. 3, 2026

(54) IMAGE CAPTURE APPARATUS AND INFORMATION PROCESSING APPARATUS, AND CONTROL METHOD FOR SAME

(71) Applicant: CANON KABUSHIKI KAISHA, Tokyo (JP)

(72) Inventor: KENICHIRO TOMITA, Chiba (JP)

(21) Appl. No.: 19/546,589

(22) Filed: Feb. 23, 2026

(30) Foreign Application Priority Data
Feb. 28, 2025 (JP) 2025-031939

(51) Int. Cl. G06F 21/64; H04L 9/32

(52) U.S. Cl. CPC G06F 21/64; H04L 9/3236

(57) ABSTRACT

Disclosed is an image capture apparatus capable of certifying the authenticity of a moving image obtained by joining split-recorded moving images with reduced processing load for joining. The apparatus obtains sequential moving image data, splits the sequential moving image data, and records them into a plurality of files. The apparatus also generates authenticity certification data of joint moving image data that is obtained by joining, in accordance with a time series, moving image data recorded in each of the plurality of files, and management data required for generation of a file for recording the joint moving image data. The apparatus then records the authenticity certification data and the management data together with the plurality of files.

### BACKGROUND

### Field of the Technology

The present disclosure relates to an image capture apparatus and an information processing apparatus, and a control method for the same.

### Description of the Related Art

Improvements in the processing power of smartphones, tablets, and the like have allowed typical users to easily edit images. Also, with advancements in editing technology through the use of AI and the like, it has become difficult to detect whether or not editing has been performed. In light of this situation, technology for certifying the authenticity of an image (certifying that the image has not been changed) has been proposed.

According to Japanese Patent Laid-Open No. 2011-124663, when image capture is performed with a digital camera, a hash value for the image data is generated and provided to the image, thereby enabling verification of whether or not the image has changed since it was captured.

In the case of recording sequential moving images or a continuous moving image to a plurality of files in accordance with conditions, the hash values of the moving images being recorded are provided to each of the files, allowing the authenticity of each of the moving images to be verified. However, in the case of generating a file that stores moving images recorded in a plurality of files as one joint moving image, it is necessary to calculate a hash value for a post-joining moving image and generate management data required by the file, and thus problems may occur relating to the amount of time and the load required for generation of the file.

### SUMMARY

At least one embodiment of the present disclosure provides an image capture apparatus that, in a case where sequential moving images are split and recorded into a plurality of files, can certify the authenticity of a moving image obtained by joining the split-recorded moving images and that can reduce the processing load required for joining.

According to an aspect of the present disclosure, there is provided an image capture apparatus comprising one or more processors that execute a program stored in a memory, wherein the program, when executed by the one or more processors, causes the image capture apparatus to: obtain sequential moving image data; split the sequential moving image data and record into a plurality of files; and generate authenticity certification data of joint moving image data that is obtained by joining, in accordance with a time series, moving image data recorded in each of the plurality of files, and management data required for generation of a file for recording the joint moving image data; and record the authenticity certification data and the management data together with the plurality of files.

Features of the present disclosure will become apparent from the following description of embodiments with reference to the attached drawings. The following description of embodiments is given by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic view illustrating a configuration example of an image processing system according to an embodiment.

FIG. 2 is a block diagram illustrating a functional configuration example of an image capture apparatus 200.

FIG. 3 is a block diagram illustrating a configuration example of an information processing apparatus 300.

FIG. 4 is a diagram illustrating a configuration example of split moving image files split via interleave recording according to a first embodiment and a joint moving image file.

FIG. 5 is a flowchart related to an example of an interleave recording operation according to the first embodiment.

FIG. 6 is a flowchart related to a file joining operation according to the first embodiment.

FIG. 7 is a diagram illustrating a configuration example of split moving image files split via file break recording according to a second embodiment and a joint moving image file.

FIG. 8 is a flowchart related to an example of a file break recording operation according to the second embodiment.

FIG. 9 is a diagram illustrating an example of a method for the split recording of moving image data.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

Note that hereinafter, a digital camera will be described as an example of an image capture apparatus according to an embodiment of the present disclosure. However, the image capture apparatus according to an embodiment of the present disclosure may be any electronic device that can record moving images. Examples of such an electronic device include video cameras, computer devices (personal computers, tablet computers, media players, PDAs, and the like), smartphones, game consoles, robots, drones, drive recorders, and the like. These are examples, and other electronic devices are not excluded.

### First Embodiment

### System Configuration

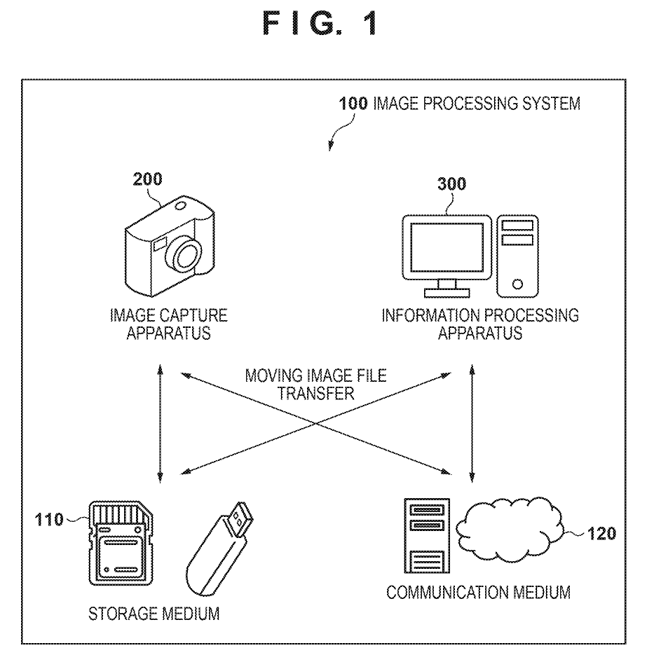

FIG. 1 is a schematic view illustrating a configuration example of an image processing system 100 according to the embodiment. The image processing system 100 includes an image capture apparatus 200 and an information processing apparatus 300. The image capture apparatus 200 generates a plurality of files obtained via split recording of moving image data. Also, the information processing apparatus 300 joins together the plurality of files obtained via split recording. In the example used here, it is expected that the plurality of files are supplied from the image capture apparatus 200 to the information processing apparatus 300 via a storage medium 110 or a communication medium 120. In the case of the former, the image capture apparatus 200 stores the files on the storage medium 110 such as a memory card, and the information processing apparatus 300 reads the files from the storage medium 110. In the case of the latter, the image capture apparatus 200 transmits the files to the information processing apparatus 300 via the communication medium 120 such as a wireless LAN or cable.

Also, in this example, the information processing apparatus 300 performs the joining of the plurality of files, but the image capture apparatus 200 may perform this. Accordingly, the information processing apparatus 300 is not essential, and in a case where the information processing apparatus 300 is not used, the communication medium 120 is also not required.

### Image Capture Apparatus Internal Configuration

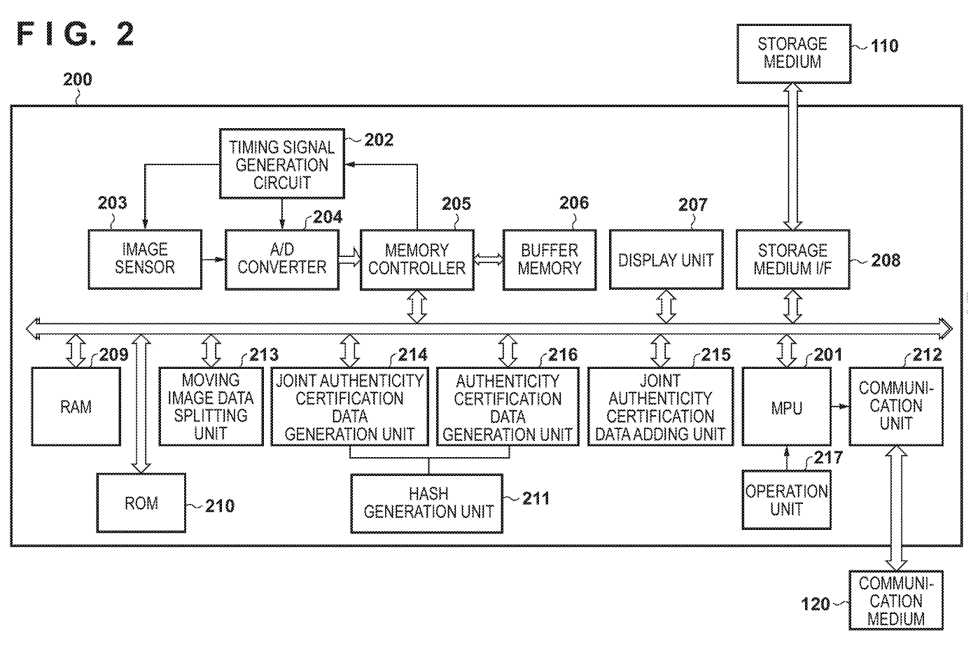

FIG. 2 is a block diagram illustrating a hardware configuration example of the image capture apparatus 200 as an example of an image processing apparatus according to an embodiment.

An MPU 201 is a microprocessor unit that can execute programs. The functions of the image capture apparatus 200 are implemented by the MPU 201 loading a program stored in a ROM 210 into a RAM 209 and controlling the operations of other circuitry as necessary.

A timing signal generation circuit 202 generates a timing signal required for the operations of an image sensor 203 and supplies the timing signal to the image sensor 203.

The image sensor 203, for example, may be a known CCD or CMOS color image sensor including a primary color Bayer array color filter. The image sensor 203 includes a pixel array including a plurality of pixels in a two-dimensional array and peripheral circuitry for reading signals from each pixel. Each pixel includes a photoelectric conversion region or a photoelectric conversion element and accumulates charge in accordance with the amount of incident light. By reading a signal having voltage in accordance with the amount of charge accumulated in the exposure period from each pixel, a pixel signal group (analog image signal) representing a subject image formed on an image plane by the optical system (not illustrated) is obtained.

An A/D converter 204 converts an analog image signal corresponding to one frame read out from the image sensor 203 into a digital image signal (image data). The image data may be still image data or may be moving image data, but in the following description, the image data is moving image data. Note that the moving image data is also accompanied by audio data, but a description relating to handling audio data is omitted.

A memory controller 205 controls moving image data, the reading and writing of a moving image file storing moving image data and the like, the refresh operation of a buffer memory 206, and the like related to the buffer memory 206.

The buffer memory 206 is a memory for temporarily storing moving image data, moving image files, intermediate data, and the like.

A display unit 207 is provided on the casing surface of the image capture apparatus 200 and displays live view video and reproduced images, a user interface such as a menu screen, settings of the image capture apparatus 200, and the like. The display unit 207 may be a liquid crystal display, an organic EL display, or the like, for example.

A storage medium I/F 208 is an interface for controlling the reading and writing of data to and from the storage medium 110. The storage medium 110 can be attachable/detachable like a memory card, for example. Also, a plurality of the storage media 110 may be used.

The RAM 209 may be used as the main memory used by the MPU 201 to read out and execute a program, as the video memory of the display unit 207, and the like.

The ROM 210 is an electrically rewritable non-volatile memory. The ROM 210 stores programs executed by the MPU 201, various types of setting values of the image capture apparatus 200, GUI data, and the like.

A hash generation unit 211 applies a known hash function such as SHA2 to input data and generates a hash value for the input data. A hash value is an example of information for certifying the authenticity (that tampering has not occurred) of the moving image data that the generation is based on.

In the present embodiment, the hash generation unit 211 accepts a split input of input data for calculating hash values. A split input refers to inputting data, for which a hash value is to be calculated, in stages. The hash generation unit 211 executes calculation of a hash value for input data until an intermediate stage, but a final hash value is not calculated until a notification of a calculation instruction or the end of the input data. The input data is no longer required at the point in time when the calculation of the has value has been executed up to an intermediate stage, and thus, it is unnecessary to store the whole moving image data from the beginning to the end of recording in order to calculate a hash value for the moving image data being recorded, the total data amount of which is indeterminate.

Note that in the present embodiment, a hash value is obtained for each of a plurality of moving image data for split recording and the moving image data obtained by joining the plurality of split-recorded moving image data. Thus, in a case where the hash generation unit 211 cannot execute calculation processing of hash values in parallel for a plurality of independent input data, individual hash generation units 211 may be provided for calculating each of the hash values.

A communication unit 212 is a communication interface compliant with one or more of a wired communication standard and a wireless communication standard (USB, wireless LAN, or the like). The image capture apparatus 200 can communicate via the communication unit 212 with an external apparatus directly or via the communication medium 120.

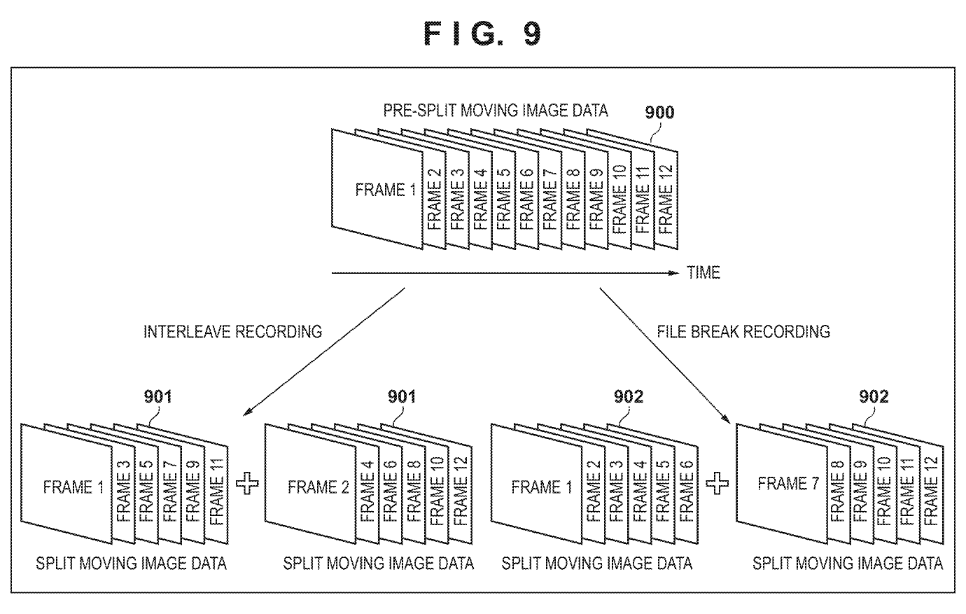

A moving image data splitting unit 213 splits sequential or continuous moving image data into a plurality of moving image files for recording. FIG. 9 illustrates an example of a splitting method that the moving image data splitting unit 213 can execute. Moving image data 900 indicates the first twelve frames of pre-split moving image data. Note that here, each frame is RAW data. RAW data is image data on which development processing has not been executed, and each pixel includes brightness information of one-color component of any one of RGB.

The development processing is, from among image processing that the MPU 201 applies to image data, sequential image processing for converting RAW data into image data of a generic format that can be used to display the RAW data as photo data, print the RAW data, and the like. Typically, the development processing includes white balance processing and color interpolation processing (demosaic processing) and may also include lens aberration correction processing, noise reduction (NR) processing, gamma (tone conversion) processing, and the like.

The moving image data splitting unit 213 executes split processing in accordance with the moving image recording method supported by the image capture apparatus 200. Here, the method used by the image capture apparatus 200 to record moving images in a plurality of files corresponds to interleave recording and file break recording.

Interleave recording is a method of recording in which a plurality of frames constituting pre-split moving images are allocated in order to a plurality of files which are the recording destination. For example, in the case of performing interleave recording into two files, the odd-numbered frames are recorded into one file and the even-numbered frames are recorded into the other file. In the example of split recording illustrated in FIG. 9, the pre-split moving image data 900 including the 12 frames is recorded as split moving image data 901 including an odd-numbered frame group and split moving image data 901 including an even-numbered frame group.

File break recording is a method in which frames are continuously recorded in a single file until the moving images satisfy a predetermined condition and the recording destination of the moving images is changed to a different file from the point in time when the predetermined condition is satisfied. The predetermined condition may be the duration, frame number, or size of the recorded file, the free capacity of the storage medium the file is being recorded to, or the like. For example, in the file break recording, assuming that the predetermined condition is the recording duration (30 minutes), the moving images of one hour are recorded into a file including moving image data for the first 30 minutes and a file including moving image data for the next 30 minutes. In other words, file break recording may be referred to as a method of recording moving images in a plurality of files in a time series order. In the example illustrated in FIG. 9, with the file break recording, the pre-split moving image data 900 including the 12 frames is recorded as split moving image data 902 including the first six frames and split moving image data 902 including the last six frames.

Note that depending on the condition and purpose, each of the files for split recording may be recorded on a separate storage medium or may be recorded on the same storage medium. For example, in a case where files are split due to the free capacity of a storage medium becoming low, each of the files is recorded on different storage media. On the other hand, in a case where files are split at regular intervals, each of the files may be recorded on the same storage medium. Also, in a case where interleave recording is performed with the purpose of high-speed recording, each of the files may be recorded on different storage media. The plurality of split-recorded files may have a part of the file name in common, may include information of other related files in the metadata, and the like to make the files required to be joined and the order be easily discernible.

Note that in a case where the moving image data is to be compression encoded using Group of Pictures (GOP) as a unit, the frames illustrated in FIG. 9 may be substituted with GOPs. In this case, after the MPU 201 applies the development processing to each frame, a group of a predetermined number of successive frames is compression encoded as a GOP. Thus, in interleave recording, split moving image data 901 including moving image data corresponding to odd-numbered GOPs and split moving image data 901 including moving image data corresponding to even-numbered GOPs, are recorded. Also, in the case of file break recording, files are split at the break between GOPs.

A joint authenticity certification data generation unit 214 generates management data for joint moving image data (alternatively, pre-split moving image data) including the moving image data split by the moving image data splitting unit 213 joined as one in time series order. Also, the joint authenticity certification data generation unit 214 obtains a hash value as authenticity certification data for the joint moving image data (alternatively, pre-split moving image data) using the hash generation unit 211. Note that this is not limited to hash values, and data compliant with a standard designed for authenticity verification can be generated as the authenticity certification data. An example of such a standard is the Coalition for Content Provenance and Authenticity (C2PA). Thus, in the following description, the hash values can be substituted with another type of authenticity certification data.

A joint authenticity certification data adding unit 215 adds the management data and the authenticity certification data generated by the joint authenticity certification data generation unit 214 to one or more of the moving image data split by the moving image data splitting unit 213.

An authenticity certification data generation unit 216 generates management data for each piece of moving image data for split recording into separate files split by the moving image data splitting unit 213. Also, the authenticity certification data generation unit 216 obtains a hash value as authenticity certification data for each piece of moving image data for split recording using the hash generation unit 211.

The management data and the authenticity certification data generated for each piece of moving image data by the authenticity certification data generation unit 216 are recorded in a moving image file (split recording file) storing the corresponding moving image data. On the other hand, for the joint moving image data in which the plurality of split-recorded moving image data are joined as one in accordance with a time series, the management data and the authenticity certification data generated by the joint authenticity certification data generation unit 214 are recorded in one or more split recording files.

The operations when the image capture apparatus 200 split records a moving image will be described below in detail.

An operation unit 217 is a generic term for an input device (buttons, switches, dials, and the like) that is provided for the user to input various types of instructions to the image capture apparatus 200. Each input device constituting the operation unit 217 has a name corresponding to the function allocated to it. For example, the operation unit 217 includes a release switch, a moving image record switch, a shooting mode selection dial for selecting the shooting mode, a menu button, a directional key, an enter key, and the like. The release switch is a switch for still image recording, and the MPU 201 recognizes a half-press state of the release switch as an image capture preparation instruction and a full-press state as an image capture start instruction. Also, the MPU 201 recognizes a press of the moving image record switch during an image capture standby state as a moving image recording start instruction and a press of the moving image record switch during the recording of a moving image as a recording stop instruction. Note that the functions allocated to the same input device may be variable. Also, the input device may be software buttons using a touch display or keys. The MPU 201 may also include an input device that supports non-contact input methods such as voice input and eye-gaze input.

Note that the image capture apparatus 200 performs moving image capture in the image capture standby state and causes the display unit 207 to function as an electronic viewfinder (EVF) by generating moving image data for display and continuously displaying this on the display unit 207. A moving image that is displayed to cause the display unit 207 to function as an EVF is referred to as a live view moving image.

The MPU 201, during the image capture standby state, applies development processing, resolution conversion processing, and the like to the moving image data stored in the buffer memory 206 and generates a live view moving image while controlling operations related to moving image capture. Also, the MPU 201 executes autoexposure (AE) and autofocus (AF) by detecting a subject region (for example, a face region of a person) from the live view moving image, generating brightness information and information related to the in-focus degree, and the like.

Also, when the MPU 201 detects a still image capture instruction via the operation unit 217, the MPU 201 generates still image data and a still image file storing the still image data and stores these in the storage medium 110. Also, when the MPU 201 detects a moving image recording start instruction via the operation unit 217, the MPU 201 generates moving image data for recording and a moving image file storing the moving image data and stores these in the storage medium 110. Note that the MPU 201 also executes encoding processing in accordance with the recording format, additional information generation processing, and the like.

### Information Processing Apparatus Internal Configuration

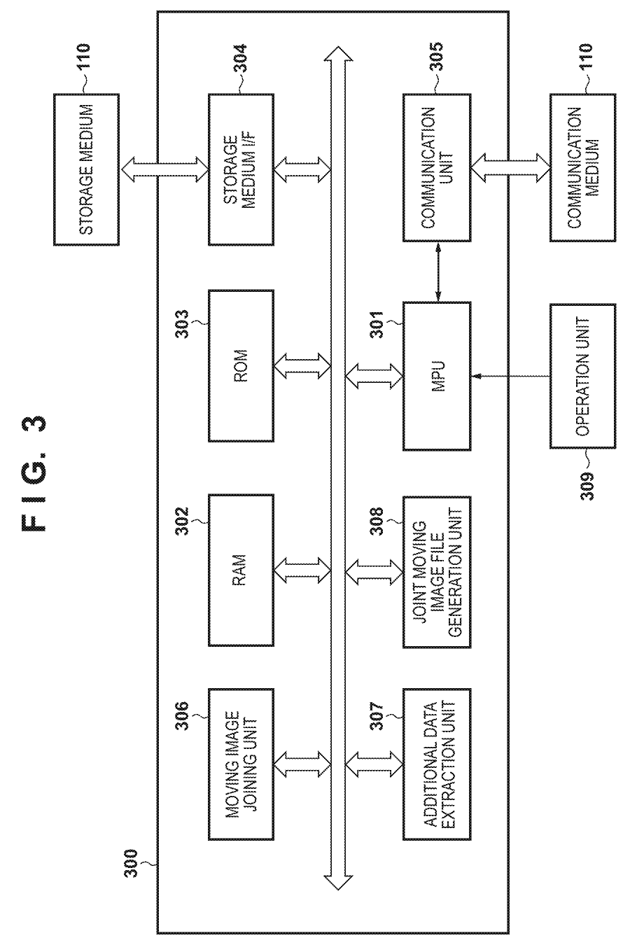

FIG. 3 is a block diagram illustrating a hardware configuration example of the information processing apparatus 300. The information processing apparatus 300 may be a general-purpose computer device such as a personal computer. However, any computer device that can process image data may be used as the information processing apparatus 300. Accordingly, the image capture apparatus 200 may be used as the information processing apparatus 300, for example. In this case, the image capture apparatus 200 may include the hardware corresponding to the blocks 306 to 308 of FIG. 3, and the functions of the blocks 306 to 308 may be executed by the MPU 201 executing a program.

An MPU 301 is a microprocessor unit that can execute programs. The functions of the information processing apparatus 300 described below are implemented by the MPU 301 loading a program stored in a ROM 303 into a RAM 302 and executing the program and controlling the operations of other circuitry as necessary.

The RAM 302 is used as a main memory used by the MPU 301 to load and execute programs, as a video memory of a display unit (not illustrated), and the like. The display unit may be included in the information processing apparatus 300 or may be an external display apparatus.

The ROM 303 is an electrically rewritable non-volatile memory. The ROM 303 stores programs (an operating system and applications) executed by the MPU 301, various types of setting values of the information processing apparatus 300, GUI data, and the like. Note that the information processing apparatus 300 may include a large-capacity storage apparatus other than the ROM 303 such as a hard disk drive (HDD) and a solid-state drive (SSD). Also, an operating system, applications, user data, and the like may be stored in the large-capacity storage apparatus.

A storage medium I/F 304 is an interface for controlling the reading and writing of data to and from the storage medium 110 of the same standard that the image capture apparatus 200 uses.

A communication unit 305 is a communication interface compliant with one or more of a wired communication standard and a wireless communication standard (USB, wireless LAN, or the like). The information processing apparatus 300 can communicate via the communication unit 305 with an external apparatus directly or via the communication medium 120.

A moving image joining unit 306 joins the plurality of split-recorded moving image data obtained via the storage medium I/F 304 or the communication medium 120 in accordance with a time series and generates a single piece of joint moving image data.

An additional data extraction unit 307 extracts the added management data and the authenticity certification data related to the joint moving image data from one or more of the plurality of moving image data joined by the moving image joining unit 306.

A joint moving image file generation unit 308 generates a joint moving image file using the management data and the authenticity certification data extracted by the additional data extraction unit 307 and the joint moving image data generated by the moving image joining unit 306.

An operation unit 309 is an input device group including a keyboard, a mouse, a touchpad, and the like. The MPU 301 detects an operation of the operation unit 309 and executes processing in accordance with the detected operation.

### Interleave Recording Operation

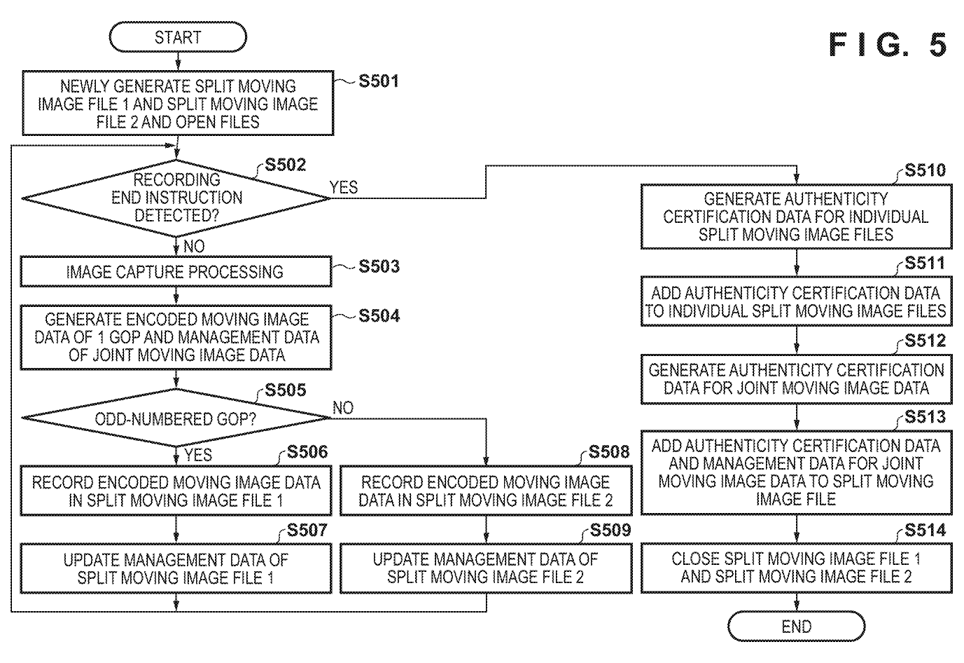

Next, as an example of an operation of split recording of moving image data by the image capture apparatus 200, an operation at the time of interleave recording into two files using GOP as a unit will be described using the flowchart of FIG. 5. Here, in particular, an operation related to recording moving image files will be focused on in the description, and known operations such as an operation to generate moving image data for recording will only be briefly described.

Note that whether or not to perform split recording of the moving image data and the type of split recording may be determined in accordance with a user setting or may be determined by the MPU 201 in accordance with the frame rate, resolution, and the like, for example.

The operation illustrated in the flowchart of FIG. 5 is started in response to the MPU 201 detecting a moving image recording start instruction via the operation unit 217 during an image capture standby state.

In S501, the MPU 201 initializes a counter that counts the number of GOPs. The counter may be a variable and can be stored in the RAM 209, for example. The initial value is 0. Also, the MPU 201 newly generates two moving image files (split moving image file 1 and split moving image file 2) for recording moving image data in the storage medium 110 and opens the files. In the present embodiment, of the generated moving image data for recording, the moving image data corresponding to odd-numbered GOPs is recorded in the split moving image file 1 and the moving image data corresponding to even-numbered GOPs is recorded in the split moving image file 2. The number of frames constituting a GOP is not particularly limited but can be an inverse of the frame rate (fps), i.e., number of frames in one second, or 1/2 of this, for example.

In S502, the MPU 201 determines whether or not a moving image recording end instruction via the operation unit 217 has been detected and executes S513 if it is determined to be detected and executes S503 if it is not determined to be detected.

In S503, the MPU 201 starts operation control of the image sensor 203 in such a manner that image capture of 1 GOP is executed.

In S504, the MPU 201 generates encoded moving image data of 1 GOP. Specifically, for each frame constituting 1 GOP, the A/D converter 204 converts an analog image signal read out from the image sensor 203 into image data, and the memory controller 205 stores the image data in the buffer memory 206. The MPU 201 applies image processing including development processing to the image data each time image data of one frame is stored in the buffer memory 206. Then, when image processing has finished being applied to the image data of 1 GOP, the MPU 201 applies encoding processing (encoding processing compliant with the MPEG4 standard, for example) using inter-frame prediction and generates encoded moving image data of 1 GOP.

Also, the joint authenticity certification data generation unit 214 generates or updates the management data for the joint moving image data in which the generated encoded moving image data has been reflected. The joint authenticity certification data generation unit 214 stores the generated management data in the RAM 209 and updates it. The management data is metadata indicating what data is stored and how the data is stored in the moving image file. Here, the moving image data is recorded in a file compliant with a container format such as ISO/IEC 14496-12, ISO/IEC 14496-14, and the like. In this case, the joint authenticity certification data generation unit 214 generates the content recorded in a moov box as the management data. The joint authenticity certification data generation unit 214 generates management data in accordance with the file format the moving image data is recorded in.

Also, the MPU 201 increases the value of the counter by one. Furthermore, the MPU 201 inputs the generated encoded moving image data of 1 GOP into the hash generation unit 211. The hash generation unit 211 processes the input encoded moving image data as split input data for calculating the hash value of the joint moving image data and split input data for calculating the hash value of image data recorded in the split moving image file 1 or 2. Note that the hash generation unit 211 determines which split moving image file 1 or 2 to processes as the split input data in accordance with the counter value. In a case where the hash generation unit 211 is separately provided for each hash value to be calculated, the MPU 201 selects one of the hash generation units 211 to which to supply the encoded moving image data in accordance with the counter value.

In S505, the MPU 201 determines whether or not the value of the counter is an odd number and executes S506 if it is determined to be odd and executes S508 if it is not determined to be odd.

In S506, the MPU 201 records the encoded moving image data of the odd-numbered GOPs stored in the buffer memory 206 in the split moving image file 1. The recorded encoded image data may be deleted from the buffer memory 206.

In S507, the authenticity certification data generation unit 216 generates management data reflecting the encoded moving image data recorded in S506. Then, the MPU 201 updates the management data recorded in the split moving image file 1 with the management data generated by the authenticity certification data generation unit 216.

In S508, the MPU 201 records the encoded moving image data of the even-numbered GOPs stored in the buffer memory 206 in the split moving image file 2. The recorded encoded image data may be deleted from the buffer memory 206.

In S509, the authenticity certification data generation unit 216 generates management data reflecting the encoded moving image data recorded in S508. Then, the MPU 201 updates the management data recorded in the split moving image file 2 with the management data generated by the authenticity certification data generation unit 216.

Note that until recording is finished, the management data may not be recorded in a split moving image file. In this case, for example, the authenticity certification data generation unit 216 holds the management data in the RAM 209 and updates the management data held in the RAM 209 in S507 and S508. The authenticity certification data generation unit 216 generates and updates the management data in a similar manner to the joint authenticity certification data generation unit 214.

The MPU 201 repeatedly executes the processing of S503 to S509 in GOP units until it is determined in S502 that an image capture end instruction has been detected.

In a case where it is determined that an image capture end instruction has been detected in S502, in S510, the authenticity certification data generation unit 216 instructs the hash generation unit 211 to calculate a hash value for the split moving image file 1 and the split moving image file 2. For each of the split moving image file 1 and the split moving image file 2, the hash generation unit 211 calculates the hash value for all of the encoded image data split input thus far and outputs this to the authenticity certification data generation unit 216.

In S511, the MPU 201 obtains the hash values to add to the split moving image file 1 and the split moving image file 2 from the authenticity certification data generation unit 216 and adds them to each of the split moving image files.

In S512, the authenticity certification data generation unit 216 instructs the hash generation unit 211 to calculate the hash value for the joint moving image data. For the joint moving image data, the hash generation unit 211 calculates the hash value for all of the encoded image data split input thus far and outputs this to the authenticity certification data generation unit 216. Note that in S510, a hash value for the joint moving image data may also be obtained, and in this case, S512 is not required.

In S513, the MPU 201 adds the hash value and the management data for the joint moving image data to at least one of the splits moving image files 1 and 2. Note that the MPU 201 may record the hash value and the management data for the joint moving image data in a different file than the split moving image file. In this case, in order to discern the relationship between the split moving image files 1 and 2, the MPU 201 can use a specific file name for files in which the hash value and the management data for the joint moving image data are recorded, can record information of the split moving image files 1 and 2 in the metadata, and the like.

In S514, the MPU 201 closes the split moving image file 1 and the split moving image file 2.

Note that instead of or in addition to storing the split moving image files 1 and 2 in the storage medium 110, the split moving image files 1 and 2 may be transmitted to an external apparatus via the communication unit 212.

### Moving Image File Configuration Example

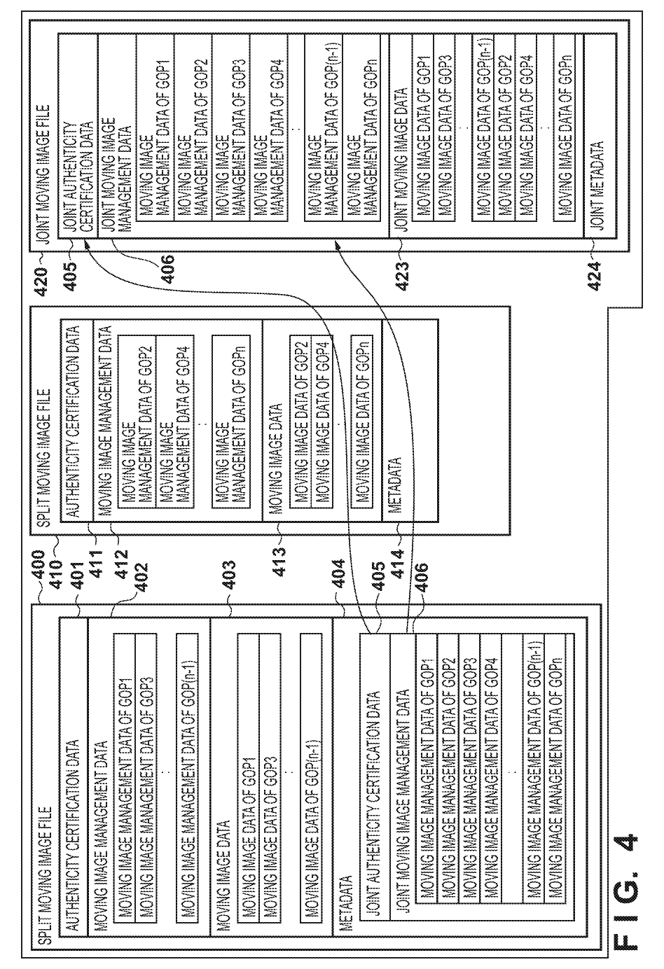

FIG. 4 is a diagram illustrating a configuration of split moving image files obtained via interleave recording and a joint moving image file obtained by joining these moving image files. Here, the odd-numbered GOPs are recorded in a split moving image file 400 and the even-numbered GOPs are recorded in a split moving image file 410. Also, a joint moving image file 420 includes the split moving image file 400 and the split moving image file 410 joined in such a manner that the GOPs are arranged in order. Note that in a case where interleave recording is performed using frames as a unit, in the configuration illustrated, the GOPs are substituted with frames.

The split moving image file 400 includes authenticity certification data 401, moving image management data 402, moving image data 403, and metadata 404.

The authenticity certification data 401 is data for certifying the authenticity (that tampering has not occurred) of the moving image data 403 and is a hash value of the moving image data 403 in this example.

The moving image management data 402 is information indicating the format, storage location, and the like of the moving image data 403.

Encoded moving image data corresponding to the odd-numbered GOPs is stored in the moving image data 403.

The metadata 404 is metadata of the split moving image file 400. In this example, at the time of split recording, the management data and the authenticity certification data related to the joint moving image data are recorded only in the split moving image file 400 from among the split moving image files 400 and 410.

Joint authenticity certification data 405 is data for certifying the authenticity of joint moving image data 423 and is a hash value of the joint moving image data 423 in this example.

Joint moving image management data 406 is management data of the joint moving image file 420.

In this manner, at the time of split recording, in one or more of a plurality of moving image files generated via split recording, the management data and the authenticity certification data of a combined moving image file storing the post-combination image data are stored, so that there is no need to generate these pieces of information at the time of combining the image data. Thus, the authenticity of the moving image data after combination can be certified and the combined moving image file can be generated at high speed.

The split moving image file 410 includes authenticity certification data 411, moving image management data 412, moving image data 413, and metadata 414. The split moving image file 410 is the same as the split moving image file 400 except that encoded moving image data corresponding to the even-numbered GOPs is stored in the moving image data 413 and information of the joint moving image file is not stored in the metadata 414.

The joint moving image file 420 includes the joint authenticity certification data 405, the joint moving image management data 406, the joint moving image data 423, and joint metadata 424. In the joint moving image data 423, encoded moving image data is stored that includes the moving image data 403 and 413 stored in the split moving image files 400 and 410 joined in such a manner that the GOPs are arranged in order. Also, the joint authenticity certification data 405 and the joint moving image management data 406 are copied from the metadata 404 of the split moving image file 400. Note that the joint authenticity certification data 405 and the joint moving image management data 406 may be copied from a different file from the split moving image file.

### Joining Operation of Split Moving Image Files Obtained via Interleave Recording

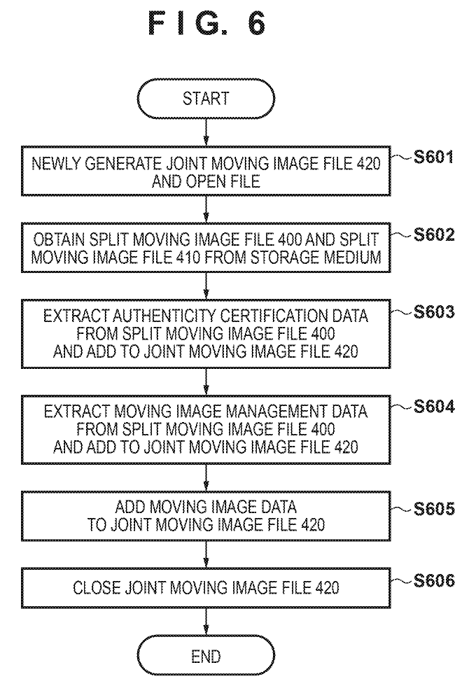

Next, an example of the operation of the information processing apparatus 300 generating the joint moving image file 420 from the split moving image files 400 and 410 will be described using the flowchart illustrated in FIG. 6. Here, the split moving image files 400 and 410 are recorded in the same storage medium 110. However, the split moving image files 400 and 410 may be recorded in different storage media and may be obtained via the communication unit 305.

In S601, the MPU 301 newly generates the joint moving image file 420 in the storage medium 110 and opens the file.

In S602, the MPU 301 opens the split moving image files 400 and 410 recorded in the storage medium 110 and starts obtaining the encoded moving image data. Note that the MPU 301 can automatically detect that the split moving image files 400 and 410 are the files to be joined via the file names, for example. Alternatively, a user may instruct the MPU 301 via the operation unit 309 that the split moving image files 400 and 410 are the files to be joined.

The MPU 301, on the basis of the management data of the split moving image files 400 and 410, recognizes that the encoded image data of the odd-numbered GOPs and the encoded image data of the even-numbered GOPs are recorded in separate moving image files. Also, the MPU 301 recognizes that, in the metadata 404 of the split moving image file 400, the management data of the joint moving image file and the authenticity certification data of the joint moving image data are stored and that these pieces of information do not need to be generated at the time of joining. In this manner, the MPU 301 determines the method for joining the image data based on the management data of the plurality of moving image files to be joined and determines whether or not the management data and the authenticity certification data used in the joint moving image file need to be generated.

In S603, the additional data extraction unit 307 extracts the joint authenticity certification data 405 from the metadata 404 of the split moving image file 400 and adds it to the joint moving image file 420.

In S604, the additional data extraction unit 307 extracts the joint moving image management data 406 from the metadata 404 of the split moving image file 400 and adds it to the joint moving image file 420. Note that, in S603, the joint authenticity certification data 405 and the joint moving image management data 406 may be collectively extracted and added to the joint moving image file 420, and in this case, S604 is unnecessary.

In S605, the MPU 301 adds the encoded moving image data stored in the split moving image file 400 and the encoded moving image data stored in the split moving image file 410 to the joint moving image data 423 in such a manner that these are arranged in a time series order.

In S606, the MPU 301 closes the joint moving image file 420.

According to the present embodiment described above, at the time of split recording of moving image data, the management data and the authenticity certification data required for the joint moving image file storing the joint moving image data including the joined split moving image data are generated and recorded. Thus, the authenticity of the moving image data obtained via split recording can be certified, and the joining processing can be executed at high speed.

### Second Embodiment

Next, the second embodiment will be described. The present embodiment performs file break recording. The configuration of the image capture apparatus 200 and the information processing apparatus 300 is the same as in the first embodiment, and thus the differences from the first embodiment will be focused on in the description.

### File Break Recording Operation

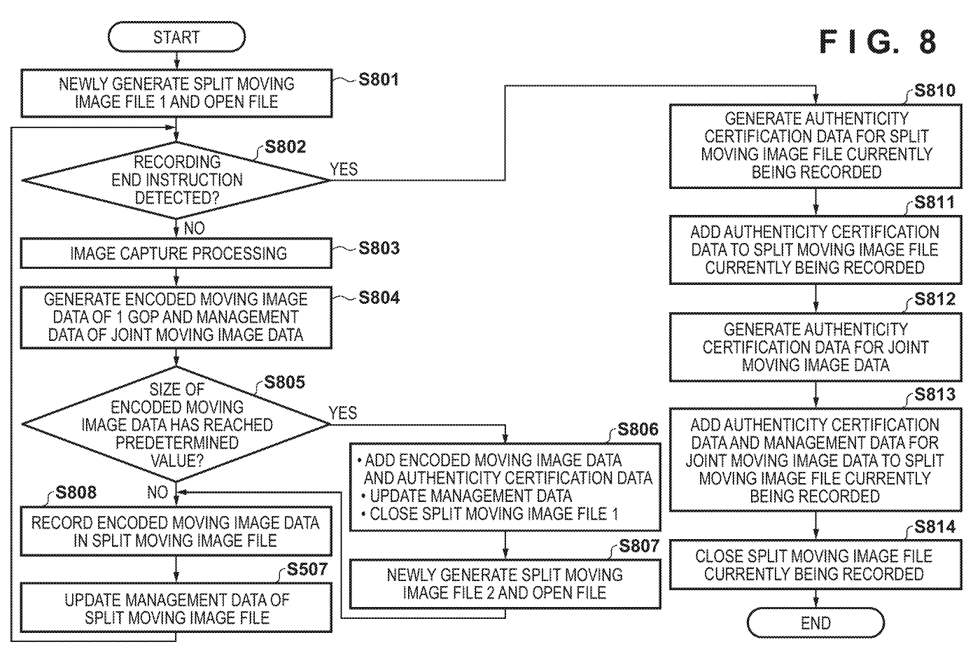

Next, the operation at the time the image capture apparatus 200 performs file break recording of the moving image data will be described using the flowchart of FIG. 8. As in the first embodiment, here in particular, an operation related to recording moving image files will be focused on in the description, and known operations such as an operation to generate moving image data for recording will only be briefly described. Also, the file break condition may be determined in accordance with a user setting or by the MPU 201.

As described above, file break can be performed in accordance with various conditions, but in this example, when the size of the encoded moving image data stored in one moving image file reaches a predetermined size (threshold), encoded image data is stored in a new image file. Also, all of the split image files are stored in the storage medium 110.

The operation illustrated in the flowchart of FIG. 8 is started in response to the MPU 201 detecting a moving image recording start instruction via the operation unit 217 during an image capture standby state.

In S801, the MPU 201 newly generates the moving image file in the storage medium 110 and opens the file. At this time, whether file break will occur is not confirmed, but for the sake of convenience, the image file to be generated will be referred to as the split moving image file 1. Also, the MPU 201 initializes the counter that counts the cumulative size of the encoded moving image data. The counter may be a variable, and its value can be stored in the RAM 209, for example. The initial value is 0.

In S802, the MPU 201 determines whether or not a moving image recording end instruction via the operation unit 217 has been detected and executes S810 if detected is determined and executes S803 if detected is not determined.

In S803, the MPU 201 starts operation control of the image sensor 203 in such a manner that image capture of 1 GOP is executed.

In S804, as in S504, the MPU 201 generates encoded moving image data of 1 GOP. Then, the MPU 201 adds the size of the encoded moving image data to the counter. Also, the joint authenticity certification data generation unit 214 generates or updates the management data for the joint moving image data in which the generated encoded moving image data has been reflected. Furthermore, the MPU 201 inputs the generated encoded moving image data of 1 GOP into the hash generation unit 211. The hash generation unit 211 processes the input encoded moving image data as split input data for calculating the hash value of the joint moving image data and split input data for calculating the hash value of image data recorded in the split moving image file currently being recorded.

In S805, the MPU 201 determines whether or not the cumulative data size of the encoded moving image data currently being recorded has reached a predetermined value and executes S806 if it is determined that the predetermined value has been reached and executes S808 if it is not determined that the predetermined value has been reached.

In S806, the MPU 201 adds the encoded moving image data generated in S804 to the split moving image file 1. The authenticity certification data generation unit 216 generates management data reflecting the added encoded moving image data. Then, the MPU 201 updates the management data recorded in the split moving image file 1 with the management data generated by the authenticity certification data generation unit 216.

Also, the authenticity certification data generation unit 216 instructs the hash generation unit 211 to calculate the hash value for the encoded moving image data of the split moving image file. For the split moving image file, the hash generation unit 211 calculates the hash value for all of the encoded image data split input thus far and outputs this to the authenticity certification data generation unit 216. The MPU 201 adds the hash value obtained from the authenticity certification data generation unit 216 to the split moving image file 1.

Thereafter, the MPU 201 closes the split moving image file 1 and initializes the counter to 0.

In S807, the MPU 201 newly generates the new moving image file (split moving image file 2) in the storage medium 110 and opens the file.

In S808, the MPU 201 adds the encoded moving image data generated in S804 to the split moving image file currently being recorded.

In S809, the authenticity certification data generation unit 216 generates management data reflecting the encoded moving image data added in S808. Then, the MPU 201 updates the management data recorded in the split moving image file currently being recorded with the management data generated by the authenticity certification data generation unit 216.

The MPU 201 repeatedly executes the processing of S803 to S809 using in GOP units until it is determined in S802 that an image capture end instruction has been detected. Note that in a case where the size of the encoded image data stored in the split moving image file currently being recorded reaches a predetermined value, a new split moving image file is generated and encoded moving image data is added to the new split moving image file.

In a case where it is determined that an image capture end instruction has been detected in S802, in S810, the authenticity certification data generation unit 216 instructs the hash generation unit 211 to calculate a hash value for the split moving image file being recorded. For the split moving image file currently being recorded, the hash generation unit 211 calculates the hash value for all of the encoded image data split input thus far and outputs this to the authenticity certification data generation unit 216.

In S811, the MPU 201 obtains the hash value to add to the split moving image file currently being recorded from the authenticity certification data generation unit 216 and adds the hash value to the split moving image file.

In S812, the authenticity certification data generation unit 216 instructs the hash generation unit 211 to calculate the hash value for the joint moving image data. For the joint moving image data, the hash generation unit 211 calculates the hash value for all of the encoded image data split input thus far and outputs this to the authenticity certification data generation unit 216. Note that in S810, a hash value for the joint moving image data may also be obtained, and in this case, S812 is not required.

In S813, the MPU 201 adds the hash value and the management data for the joint moving image data to the split moving image file currently being recorded. Note that the MPU 201 may record the hash value and the management data for the joint moving image data in a different file from the split moving image file. In this case, the MPU 201 makes the relationship between (i) the file in which the hash value and the management data for the joint moving image data are recorded and (ii) the recorded split moving image file identifiable.

In S814, the MPU 201 closes the split moving image file currently being recorded.

Note that instead of or in addition to storing the split moving image file in the storage medium 110, the split moving image file may be transmitted to an external apparatus via the communication unit 212.

### Moving Image File Configuration Example

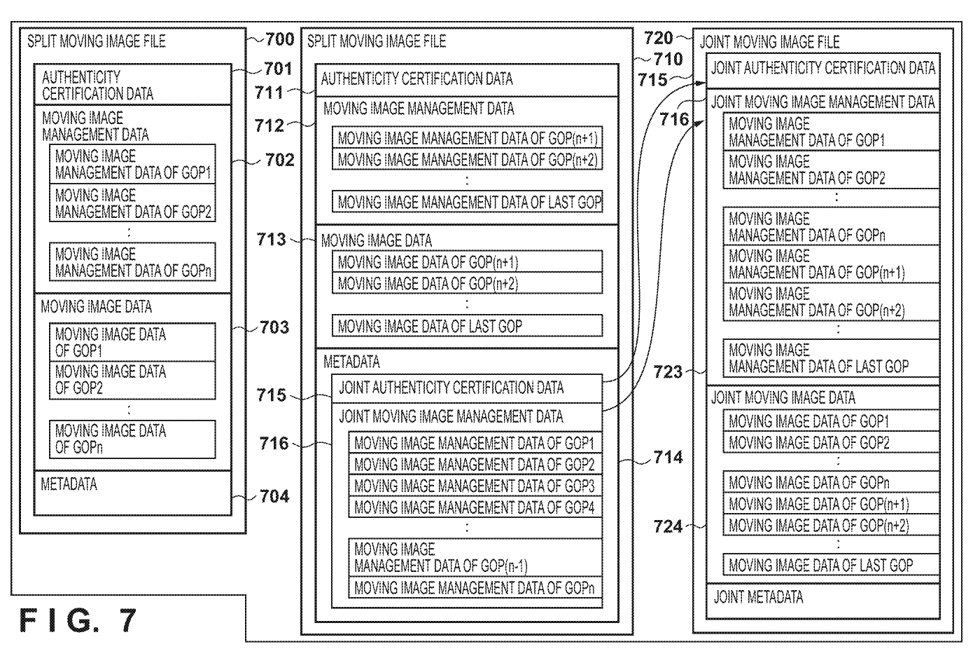

FIG. 7 is a diagram illustrating a configuration of split moving image files obtained via file break recording and a joint moving image file obtained by joining these moving image files. Here, the encoded moving image data is recorded in order of a split moving image file 700 and a split moving image file 710. Also, a joint moving image file 720 includes the split moving image file 700 and the split moving image file 710 joined in such a manner that the GOPs are arranged in order. Note that in a case where GOP units are not used in encoding, in the configuration illustrated, the GOPs are substituted with frames.

The split moving image file 700 includes authenticity certification data 701, moving image management data 702, moving image data 703, and metadata 704.

The authenticity certification data 701 is data for certifying the authenticity (that tampering has not occurred) of the moving image data 703 and is a hash value of the moving image data 703 in this example.

The moving image management data 702 is information indicating the format, storage location, and the like of the moving image data 703.

The encoded moving image data from the start of recording to when the file break condition is satisfied is stored in the moving image data 703.

The metadata 704 is metadata of the split moving image file 700.

The split moving image file 710 includes authenticity certification data 711, moving image management data 712, moving image data 713, and metadata 714. The split moving image file 710 is the same as the split moving image file 700 except that encoded moving image data corresponding to the GOP following the moving image data 703 is stored in the moving image data 713 and information of the joint moving image file is stored in the metadata 714.

In this example, since the split moving image file 710 is the last recorded split moving image file, the management data and the authenticity certification data related to the joint moving image data are recorded only in the split moving image file 710 from among the split moving image files 700 and 710.

Joint authenticity certification data 715 is data for certifying the authenticity of joint moving image data 723 and is a hash value of the joint moving image data 723 in this example.

Joint moving image management data 716 is management data of the joint moving image file 720.

In this manner, according to the present embodiment, at the time of file break recording, the management data and the authenticity certification data of the combined moving image file storing the combined image data are recorded in the last recorded moving image file. Thus, even at the time of file break recording, a similar effect to that of the first embodiment can be achieved.

The joint moving image file 720 includes the joint authenticity certification data 715, the joint moving image management data 716, the joint moving image data 723, and joint metadata 724. In the joint moving image data 723, encoded moving image data is stored that includes the moving image data 703 and 713 stored in the split moving image files 700 and 710 joined in such a manner that the GOPs are arranged in order. Also, the joint authenticity certification data 715 and the joint moving image management data 716 are copied from the metadata 714 of the split moving image file 710. Note that the joint authenticity certification data 715 and the joint moving image management data 716 may be copied from a different file from the split moving image file.

### Joining Operation of Split Moving Image Files Obtained via File Break Recording

Note that the operation of the information processing apparatus 300 generating the joint moving image file 720 from the split moving image files 700 and 710 is essentially the same as the joining operation of the split moving image files obtained via interleave recording described in the first embodiment using FIG. 6.

Specifically, the joint moving image file 720 can be generated via processing in which the split moving image files 400 and 410 in FIG. 6 are substituted with the split moving image files 700 and 710.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-031939, filed February 28, 2025, which is hereby incorporated by reference herein in its entirety.

What is claimed is:

1. An image capture apparatus comprising one or more processors that execute a program stored in a memory, wherein the program, when executed by the one or more processors, causes the image capture apparatus to:
obtain sequential moving image data;
split the sequential moving image data and record into a plurality of files; and
generate authenticity certification data of joint moving image data that is obtained by joining, in accordance with a time series, moving image data recorded in each of the plurality of files, and management data required for generation of a file for recording the joint moving image data; and
record the authenticity certification data and the management data together with the plurality of files.

2. The image capture apparatus according to claim 1, wherein
the sequential moving image data is recorded into the plurality of files with interleave recording.

3. The image capture apparatus according to claim 2, wherein
the authenticity certification data and the management data are recorded in one or more of the plurality of files.

4. The image capture apparatus according to claim 1, wherein
the sequential moving image data is recorded into the plurality of files with file break recording.

5. The image capture apparatus according to claim 4, wherein
the authenticity certification data and the management data are recorded in a last recorded file among the plurality of files.

6. The image capture apparatus according to claim 1, wherein
the authenticity certification data and the management data are recorded in a file different from the plurality of files.

7. The image capture apparatus according to claim 1, wherein
the authenticity certification data is a hash value of the joint moving image data.

8. An information processing apparatus comprising one or more processors that execute a program stored in a memory, wherein the program, when executed by the one or more processors, causes the information processing apparatus to:
obtain files recorded by the image capture apparatus according to claim 1;
generate joint moving image data by joining, in a time series order, moving image data recorded in, from among the obtained files, each of a plurality of files into which sequential moving image data was recorded with split recording;
extract the authenticity certification data and the management data from a file among the obtained files; and
generate an image file storing the joint moving image data, using the joint moving image data, the authenticity certification data, and the management data.

9. The information processing apparatus according to claim 8, wherein
the authenticity certification data and the management data are extracted from one of the plurality of files.

10. The information processing apparatus according to claim 8, wherein
the authenticity certification data and the management data are extracted from a file different from the plurality of files.

11. A control method of an image capture apparatus comprising:
split sequential moving image data and recording into a plurality of files; and
generating authenticity certification data of joint moving image data that is obtained by joining, in accordance with a time series, moving image data recorded in each of the plurality of files, and management data required for generation of a file for recording the joint moving image data; and
recording the authenticity certification data and the management data together with the plurality of files.

12. A control method of an information processing apparatus comprising:
obtaining files recorded by the image capture apparatus according to claim 1;
generating joint moving image data by joining, in a time series order, moving image data recorded in, from among the obtained files, each of a plurality of files into which sequential moving image data was recorded with split recording;
extracting the authenticity certification data and the management data from a file among the obtained files; and
generating an image file storing the joint moving image data, using the joint moving image data, the authenticity certification data, and the management data.

13. A non-transitory computer-readable medium storing a program executable by one or more processors, wherein the program, when executed by the one or more processors, causes the one or more processors to perform a control method of an image capture apparatus comprising:
split sequential moving image data and recording into a plurality of files; and
generating authenticity certification data of joint moving image data that is obtained by joining, in accordance with a time series, moving image data recorded in each of the plurality of files, and management data required for generation of a file for recording the joint moving image data; and
recording the authenticity certification data and the management data together with the plurality of files.

14. A non-transitory computer-readable medium storing a program executable by one or more processors, wherein the program, when executed by the one or more processors, causes the one or more processors to perform a control method of an information processing apparatus comprising:
obtaining files recorded by the image capture apparatus according to claim 1;
generating joint moving image data by joining, in a time series order, moving image data recorded in, from among the obtained files, each of a plurality of files into which sequential moving image data was recorded with split recording;
extracting the authenticity certification data and the management data from a file among the obtained files; and
generating an image file storing the joint moving image data, using the joint moving image data, the authenticity certification data, and the management data.
